(19) United States
(12) Patent Application Publication
(10) Pub. No.: US 2025/0266630 A1
(43) Pub. Date: Aug. 21, 2025

(54) CONNECTOR AND METHOD FOR MANUFACTURING CONNECTOR

(71) Applicant: HIROSE ELECTRIC CO., LTD., Kanagawa (JP)

(72) Inventor: Yuki SATAKE, Kanagawa (JP)

(21) Appl. No.: 19/050,617

(22) Filed: Feb. 11, 2025

(30) Foreign Application Priority Data
Feb. 21, 2024 (JP) 2024-024289

(51) Int. Cl. H01R 12/71; H01R 13/405; H01R 43/16; H01R 43/24

(52) U.S. Cl. CPC H01R 12/716; H01R 13/405; H01R 43/16; H01R 43/24

(57) ABSTRACT

Provided is a connector which includes: a housing; and a plurality of contact rows held by the housing, the plurality of contact rows extends along a first direction, and includes a first contact row and a second contact row arranged adjacent to each other in a second direction perpendicular to the first direction, the first contact row includes a plurality of first contacts, the second contact row includes a plurality of second contacts, a pair of opposing first and second contacts is disposed such that one of the first and second contacts includes the other one of the first and second contacts when viewed in the second direction, and the first cut surface of each of the plurality of first contacts and the second cut surface of each of the plurality of second contacts are located between the first contact row and the second contact row in the second direction.

### CROSS-REFERENCE TO RELATED APPLICATION

This application claims priority from Japanese Patent Application No. 2024-024289 filed with the Japan Patent Office on Feb. 21, 2024, the entire content of which is hereby incorporated by reference.

### BACKGROUND

### 1. Technical Field

The present disclosure relates to a connector and a method for manufacturing a connector.

### 2. Related Art

JP-A-2021-44080 discloses one example of a method for manufacturing a connector having a plurality of contact rows. In the technique of JP-A-2021-44080, when the connector having the plurality of contact rows is manufactured, all contacts of two adjacent contact rows are coupled to one carrier. Thus, the contacts forming one of the adjacent contact rows are arranged at locations other than locations completely overlapping with the contacts forming the other contact row in a direction perpendicular to a row extending direction, i.e., coupling portions connecting the contacts forming one of the two adjacent contact rows to the carrier and coupling portions connecting the contacts forming the other contact row to the carrier are provided at non-overlapping locations in a direction perpendicular to a row arrangement direction. In the configuration of JP-A-2021-44080, when the connector is manufactured, the plurality of contacts of each of the two adjacent contact rows is collectively press-fitted in a connector housing with coupled to the one carrier. Thereafter, the contacts are cut from the carrier using a carrier cutting tool.

### SUMMARY

A connector according to an embodiment of the present disclosure is configured to include: a housing; and a plurality of contact rows held by the housing, in which the plurality of contact rows linearly extends along a first direction, is apart from each other in a second direction perpendicular to the first direction, and includes at least a first contact row and a second contact row arranged adjacent to each other in the second direction, the first contact row includes a plurality of first contacts, the second contact row includes a plurality of second contacts, and each of the plurality of first contacts and each of the plurality of second contacts extend along the second direction, at least some of the plurality of first contacts and at least some of the plurality of second contacts face each other in the second direction, a pair of opposing first and second contacts is disposed such that one of the first and second contacts includes the other one of the first and second contacts when viewed in the second direction, and each of the plurality of first contacts has a first cut surface formed along a direction crossing a plane formed by the first direction and the second direction, each of the plurality of second contacts has a second cut surface formed along the direction crossing the plane formed by the first direction and the second direction, and the first cut surface and the second cut surface are located between the first contact row and the second contact row in the second direction.

### BRIEF DESCRIPTION OF THE DRAWINGS

FIG. 1 is a perspective view showing a plug connector according to the present embodiment together with a receptacle connector;

FIG. 2 is a sectional view taken along A-A line of FIG. 1;

FIG. 3 is a plan view of the plug connector according to one embodiment of the present disclosure;

FIG. 4 is a bottom view of the plug connector of FIG. 3;

FIG. 5 is a plan view of the receptacle connector;

FIG. 6 is a bottom view of the receptacle connector of FIG. 5;

FIG. 7 is a partial sectional perspective view of the section of the receptacle connector taken along B-B line of FIGS. 5 and 6 from the bottom, which shows a state before contacts are fixed to a housing;

FIG. 8 is a partial sectional perspective view of the section of the receptacle connector taken along B-B line of FIGS. 5 and 6 from the bottom, which shows a state after the contacts have been fixed to the housing;

FIG. 9 is a perspective view of contact assemblies from the top for describing a method for manufacturing the plug connector;

FIG. 10 is a perspective view of the contact assemblies of FIG. 9 from the bottom;

FIG. 11 is a perspective view of contact sets included in the contact assemblies;

FIG. 12 is a perspective view of the contact sets of FIG. 11 from a different angle;

FIG. 13 is a perspective view of the molded contact assemblies from the top for describing the method for manufacturing the plug connector;

FIG. 14 is a perspective view of the contact assemblies of FIG. 13 from the bottom;

FIG. 15 is a perspective view of the contact assemblies after a cutting step from the top for describing the method for manufacturing the plug connector;

FIG. 16 is a perspective view of the contact assemblies of FIG. 15 from the bottom;

FIG. 17 is a perspective view showing the final shape of the contacts; and

FIG. 18 is a perspective view of the contacts of FIG. 17 from a different angle.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

However, in the configuration of the connector of JP-A-2021-44080, the number of coupling portions corresponding to the number of contacts provided in the contact rows are necessary, and these many coupling portions need to be densely provided particularly in the row extending direction at the one carrier. For this reason, it is difficult to narrow a pitch between the contacts in the row arrangement direction and reduce the connector in size. Moreover, many portions of the coupling portions are finally discarded after having been cut from the carrier. The amount of waste increases as the number of coupling portions increases, which leads to a problem in effective resource use.

One object of the present disclosure is to provide a method for manufacturing a connector, which solves the above-described problems. Specifically, one object is to provide a method for manufacturing a connector, which can easily narrow a pitch between contacts in a row arrangement direction and reduce the connector in size and can achieve effective resource use and a connector with a narrow pitch between contacts in a row arrangement direction and a reduced size.

A connector according to an aspect of the present disclosure includes: a housing; and a plurality of contact rows held by the housing, in which the plurality of contact rows linearly extends along a first direction, is apart from each other in a second direction perpendicular to the first direction, and includes at least a first contact row and a second contact row arranged adjacent to each other in the second direction, the first contact row includes a plurality of first contacts, the second contact row includes a plurality of second contacts, and each of the plurality of first contacts and each of the plurality of second contacts extend along the second direction, at least some of the plurality of first contacts and at least some of the plurality of second contacts face each other in the second direction, a pair of opposing first and second contacts is disposed such that one of the first and second contacts includes the other one of the first and second contacts when viewed in the second direction, and each of the plurality of first contacts has a first cut surface formed along a direction crossing a plane formed by the first direction and the second direction, each of the plurality of second contacts has a second cut surface formed along the direction crossing the plane formed by the first direction and the second direction, and the first cut surface and the second cut surface are located between the first contact row and the second contact row in the second direction.

According to the connector of the present disclosure, the pitch between the contacts in the second direction can be narrowed, and the connector can be reduced in size.

A method for manufacturing a connector according to an aspect of the present disclosure is a method for manufacturing the connector according to the present disclosure described above, the method including: punching a metal plate to form a plurality of band-shaped members connected to each other through a carrier on one end side in the second direction; bending, in a shape of the first contact, a first intermediate portion of each of the plurality of band-shaped members between a first coupling portion located on the one end side in the second direction and a second coupling portion located on the other end side in the second direction; bending, in a shape of the second contact, part of each of the plurality of band-shaped members located on the other end side in the second direction with respect to the second coupling portion; forming the housing such that the housing holds at least part of each of the plurality of band-shaped members; cutting the carrier and the first coupling portion; and cutting out part of the second coupling portion.

According to the method for manufacturing the connector according to the present disclosure, the first contact and the second contact can be formed from one band-shaped member. Thus, the pitch between the contacts in the second direction can be easily narrowed, and the connector can be easily reduced in size.

According to the present disclosure, the method for manufacturing the connector, which can easily narrow the pitch between the contacts in the row arrangement direction and reduce the connector in size and can achieve the effective resource use and the connector with the narrow pitch between the contacts in the row arrangement direction and the reduced size can be provided.

Hereinafter, an exemplary embodiment for carrying out the present disclosure will be described in detail with reference to the drawings. Note that materials, shapes, relative component locations, and the like described in the embodiment below are arbitrary without departing from the gist of the present disclosure, and are changeable according to the configuration of a device to which the present disclosure is applied or various conditions. Moreover, the scope of the present disclosure is not limited to the embodiment specifically described below.

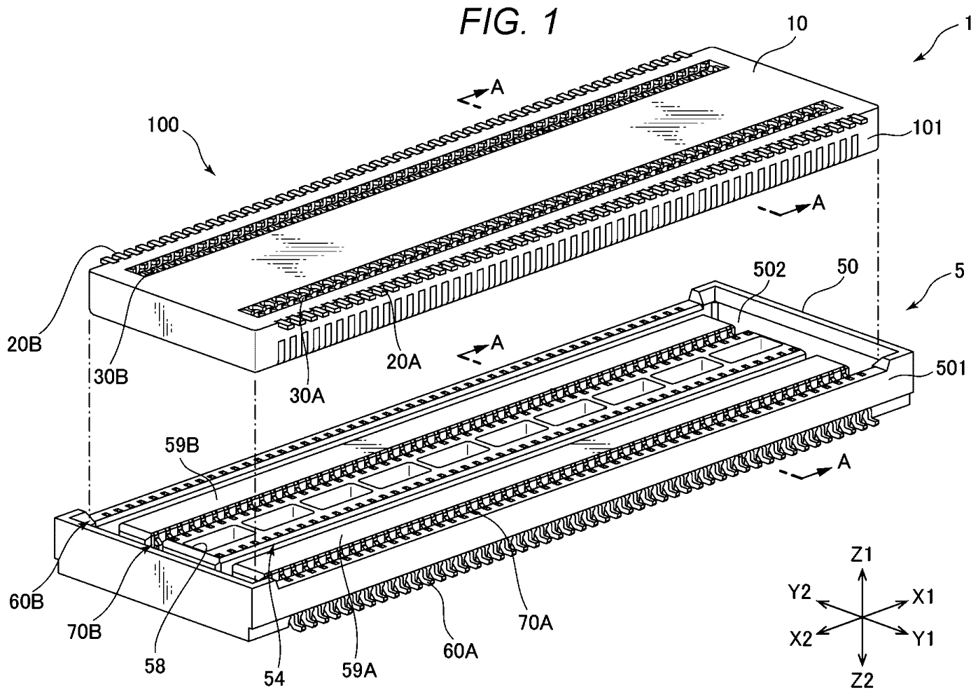

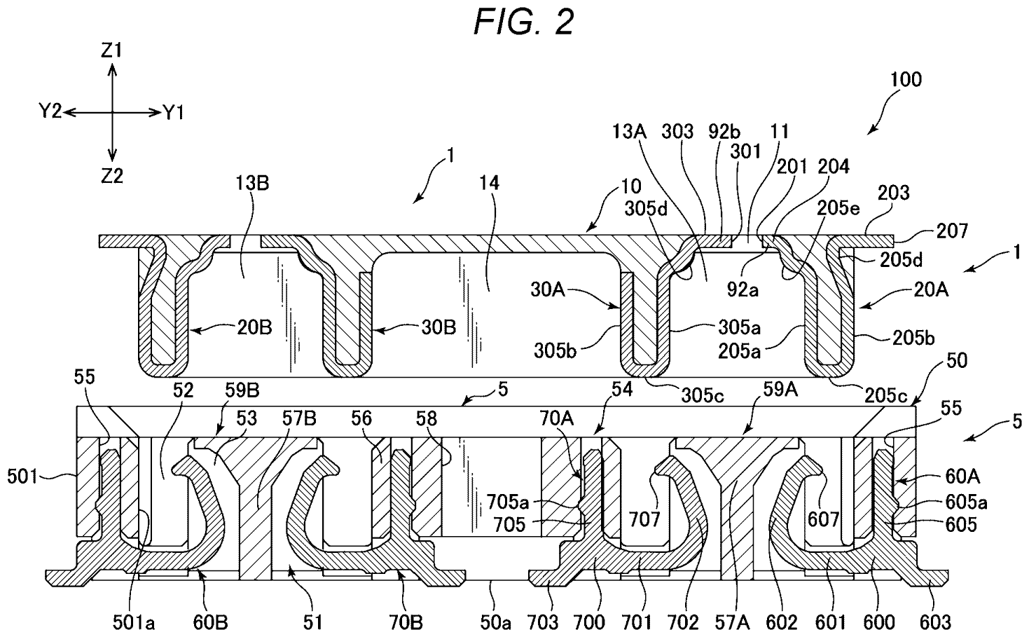

FIG. 1 shows a perspective view of a plug connector according to the present embodiment together with a receptacle connector. FIG. 2 shows a sectional view taken along A-A line of FIG. 1. Such a pair of plug connector 1 and receptacle connector 5 forms a connector assembly 100, and is fittable in each other. FIGS. 1 and 2 show a state before the plug connector 1 and the receptacle connector 5 are fitted in each other.

In the present embodiment, the length directions of the plug connector 1 and the receptacle connector 5 will be described as an “X”-direction (first direction), a width direction perpendicular to the X-direction will be described as a “Y”-direction (second direction), and a height direction perpendicular to the X-direction and the Y-direction will be described as a “Z”-direction (third direction).

The plug connector 1 and the receptacle connector 5 are detachably fittable in each other in the Z-direction which is a direction crossing an “X-Y” plane formed by the X-direction and the Y-direction, for example a direction perpendicular to the “X-Y” plane.

In the description below, one side and the other side in the X-direction will be referred to as an X1-direction and an X2-direction, one side and the other side in the Y-direction will be referred to as a Y1-direction and a Y2-direction, and one side and the other side in the Z-direction will be referred to as a Z1-direction and a Z2-direction.

Each of the plug connector 1 and the receptacle connector 5 is substantially in a rectangular flat plate shape in the “X-Y” plane, and has a symmetrical shape in the X-direction and the Y-direction.

In the description below, the same reference numeral as that of a member on one side is used to represent a corresponding member on the other side. In a case where a member located on one side and a member located on the other side are distinguished from each other for the sake of convenience, a character “A” is assigned to the reference numeral of the member located on the one side, and a character “B” is assigned to the reference numeral of the member located on the other side.

The plug connector 1 has a housing 10 having insulating properties and made of resin and a plurality of contacts 20 and contacts 30 held by the housing 10 by insert molding. The contact 20 and the contact 30 have different shapes, and the contact 20 is located outside the housing 10 in the Y-direction with respect to the contact 30. For example, the contact 20A is located on the Y1 side with respect to the contact 30A, and the contact 20B is located on the Y2 side with respect to the contact 30B. Both the contact 20 and the contact 30 are formed of metal plates, and have conductivity.

Each of the contacts 20A, 30A, 30B, 20B forms, together with part of the housing 10, a raised portion protruding in the Z2-direction. Moreover, the contact 20A and the contact 30A form, between the contact 20A and the contact 30A in the Y-direction, a fitting recessed portion 13A recessed in the Z1-direction. Similarly, the contact 30B and the contact 20B form, between the contact 30B and the contact 20B in the Y-direction, a fitting recessed portion 13B recessed in the Z1-direction. Further, the contact 30A and the contact 30B form, between the contact 30A and the contact 30B in the Y-direction, a center fitting recessed portion 14 recessed in the Z1-direction. Part (contact portions 205a, 305a and the like) of the contacts 20A, 30A, 30B, 20B is exposed in the fitting recessed portion 13A, the fitting recessed portion 13B, and the center fitting recessed portion 14.

The receptacle connector 5 has a housing 50 having insulating properties and made of resin and a plurality of contacts 60 and contacts 70 held by the housing 50 by press-fitting. The contact 60 and the contact 70 have the same size and shape, and the contact 60A and the contact 70A face each other and are symmetrically arranged in the Y-direction and the contact 60B and the contact 70B face each other and are symmetrically arranged in the Y-direction. Both the contacts 60, 70 are formed of metal plates, and have conductivity.

Part (horizontal bottom portion 601, elastic arm portion 602, horizontal bottom portion 701, elastic arm portion 702, and the like) of the contacts 60A, 70A, 60B, 70B forms, together with part of the housing 50, a recessed portion 52 recessed in the Z2-direction. Moreover, at a location sandwiched between the contact 60A and the contact 70A in the Y-direction, the contact 60A and the contact 70A form, together with part (partition wall 57 and the like) of the housing 50, a fitting raised portion 59A protruding in the Z1-direction. Similarly, at a location sandwiched between the contact 70B and the contact 60B in the Y-direction, the contact 70B and the contact 60B form, together with part (partition wall 57 and the like) of the housing 50, a fitting raised portion 59B protruding in the Z1-direction. Moreover, at a location sandwiched between the contact 70A and the contact 70B in the Y-direction, the contact 70A and the contact 70B form, also using part (center partition wall 56 and the like) of the housing 50, a center fitting raised portion 54 protruding in the Z1-direction.

Each of the fitting raised portion 59A, the fitting raised portion 59B, and the center fitting raised portion 54 is in an island shape in the “X-Y” plane. A rectangular frame-shaped groove portion 502 is formed between the island-shaped portions formed by the fitting raised portion 59A, the fitting raised portion 59B, and the center fitting raised portion 54 and a peripheral wall 501 of the receptacle connector 5. Part (contact point 607, contact point 707, and the like) of the contacts 60A, 70A, 70B, 60B is exposed in the fitting raised portion 59A, the fitting raised portion 59B, and the center fitting raised portion 54.

When the plug connector 1 and the receptacle connector 5 are fitted in each other, a rectangular frame-shaped peripheral wall 101 of the plug connector 1 is fitted in the groove portion 502 of the receptacle connector 5. Moreover, at this time, four raised portions formed by the contacts 20A, 30A, 30B, 20B and the like of the plug connector 1 are each fitted in the four recessed portions 52 formed by the contacts 60A, 70A, 60B, 70B and the like of the receptacle connector 5. Further, the fitting raised portion 59A, fitting raised portion 59B, and center fitting raised portion 54 of the receptacle connector 5 are each fitted in the fitting recessed portion 13A, fitting recessed portion 13B, and center fitting recessed portion 14 of the plug connector 1.

As a result, the contact portions 205a, 305a and the like which are the exposed portions of the contacts 20A, 30A, 30B, 20B of the plug connector 1 provided in the fitting recessed portion 13A, the fitting recessed portion 13B, and the center fitting recessed portion 14 each contact the contact points 607, 707 and the like which are the exposed portions of the contacts 60A, 70A, 70B, 60B of the receptacle connector 5 provided in the fitting raised portion 59A, the fitting raised portion 59B, and the center fitting raised portion 54. Accordingly, the contacts 20, 30 of the plug connector 1 and the contacts 60, 70 of the receptacle connector 5 are electrically connected to each other.

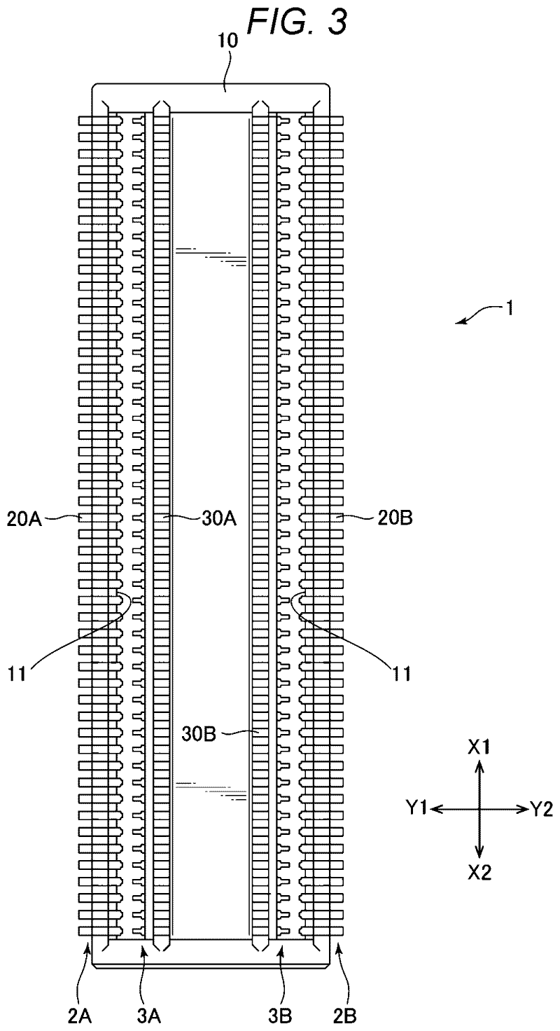

In addition to FIGS. 1 and 2, the plug connector 1 will be described in more detail with reference to FIGS. 3 and 4. FIG. 3 shows a plan view of the plug connector 1, and FIG. 4 shows a bottom view of the plug connector 1.

Each of the contacts 20A, 30A, 20B, 30B linearly extends along the Y-direction. The plurality of contacts 20A, 30A, 20B, 30B is arranged apart from each other at equal intervals in the X-direction.

The plurality of contacts 20A, 30A forms contact rows 2A, 3A, and the plurality of contacts 20B, 30B forms contact rows 2B, 3B. That is, in the present embodiment, the plug connector 1 has four contact rows 2A, 3A, 2B, 3B.

Note that in the description below, the contacts 20A, 20B may be referred to as a contact 20 (first contact), and the contacts 30A, 30B may be referred to as a contact 30 (second contact).

Moreover, the contact rows 2A, 2B may be referred to as a contact row 2 (first contact row), and the contact rows 3A, 3B may be referred to as a contact row 3 (second contact row).

The contact row 2A and the contact row 3A located adjacent to each other and facing each other in the Y-direction form one pair, and similarly, the contact row 2B and the contact row 3B located adjacent to each other and facing each other in the Y-direction form another pair.

The contacts 20A forming the contact row 2A of the one pair and the contacts 30A forming the contact row 3A of the one pair extend along the Y-direction, and are arranged at completely-overlapping locations in the Y-direction. Similarly, the contacts 20B forming the contact row 2B of the another pair and the contacts 30B forming the contact row 3B of the another pair are arranged at completely-overlapping locations in the Y-direction. Further, the pair of contacts 20A, 30A and the pair of contacts 20B, 30B are also arranged at completely-overlapping locations in the Y-direction.

The contact 20 has the contact portion 205a. The contact portion 205a is located between the contact row 2 and the contact row 3. The contact portion 205a forms part of the fitting recessed portion 13, and when the plug connector 1 and the receptacle connector 5 are fitted in each other, is contactable with a corresponding portion (contact point 607) of the receptacle connector 5.

The contact 20 has, on one end side in the Y-direction, a first mount portion 203 extending outward of the housing 10, and has, on the other end side, a third mount portion (first mount portion 204 and second mount portion 92a) extending inward of the housing 10. The third mount portion includes two portions which are the first mount portion 204 and the second mount portion 92a. The second mount portion 92a is a portion forming an end portion of the contact 20 on the other end side, and is formed narrower in the X-direction than the first mount portion 204 and other portions of the contact 20.

A top portion 205c substantially flat in the Y-direction, a standing portion 205b extending along the Z-direction, and a bent portion 205d bent slightly inward as extending inward of the housing 10 are provided in this order between the contact portion 205a and the first mount portion 203. On the other hand, a step portion 205e bent slightly outward as extending inward of the housing 10 is provided between the contact portion 205a and the first mount portion 204.

A gap formed between the first mount portion 203 and the first mount portion 204 of the third mount portion is filled with the resin of the housing 10. Moreover, the bent portion 205d is embedded in the peripheral wall 501 of the housing 10. Other portions of the contact 20 are exposed to the outside.

The first mount portion 203 has a cut surface 207 (third cut surface) formed along the Z-direction, for example. Moreover, the second mount portion 92a has a cut surface 201 (first cut surface) formed along the Z-direction, for example. The cut surface 207 and the cut surface 201 are cut at the same angle with respect to the “X-Y” plane. In order to form the cut surface 201, the housing 10 is provided with a through-hole 11 penetrating the housing 10 along the Z-direction.

The contact 30 has the contact portion 305a located between the contact row 2 and the contact row 3 and extending along the Z-direction. The contact portion 305a forms part of the fitting recessed portion 13, and when the plug connector 1 and the receptacle connector 5 are fitted in each other, is contactable with a corresponding portion (contact point 707) of the receptacle connector 5.

The contact 30 has, on one end side in the Y-direction, a linear portion 305b extending along the Z-direction, and has, on the other end side, a second mount portion (first mount portion 303 and third mount portion 92b) extending outward of the housing 10. The second mount portion includes two portions which are the first mount portion 303 and the third mount portion 92b. The third mount portion 92b is a portion forming an end portion of the contact 30 on the other end side, and is formed narrower in the X-direction than the first mount portion 303 and other portions of the contact 30.

A top portion 305c substantially flat in the Y-direction is provided between the contact portion 305a and the linear portion 305b, and on the other hand, a step portion 305d bent slightly outward as extending outward of the housing 10 is provided between the contact portion 305a and the first mount portion 303. The surface of the step portion 305d is covered with a thin layer of resin. When solder is applied to the second mount portion (303, 92b) adjacent to the step portion 305d, such a resin layer reduces a probability of the solder reaching the contact portion 305a through the step portion 305d. Thus, influence of the solder on contact between the contact portion 305a and the corresponding portion (contact point 707) of the receptacle connector 5 can be reduced.

A gap formed between the first mount portion 303 and the linear portion 305b is filled with the resin of the housing 10. Moreover, a tip end portion of the linear portion 305b is embedded in the housing 10. Other portions of the contact 30 are exposed to the outside.

The third mount portion 92b has a cut surface 301 (second cut surface) formed along the Z-direction, for example. The cut surface 301 is formed, as in the cut surface 201, using the through-hole 11 of the housing 10. Thus, the cut surface 301 has the same angle as that of the cut surface 201 with respect to the “X-Y” plane.

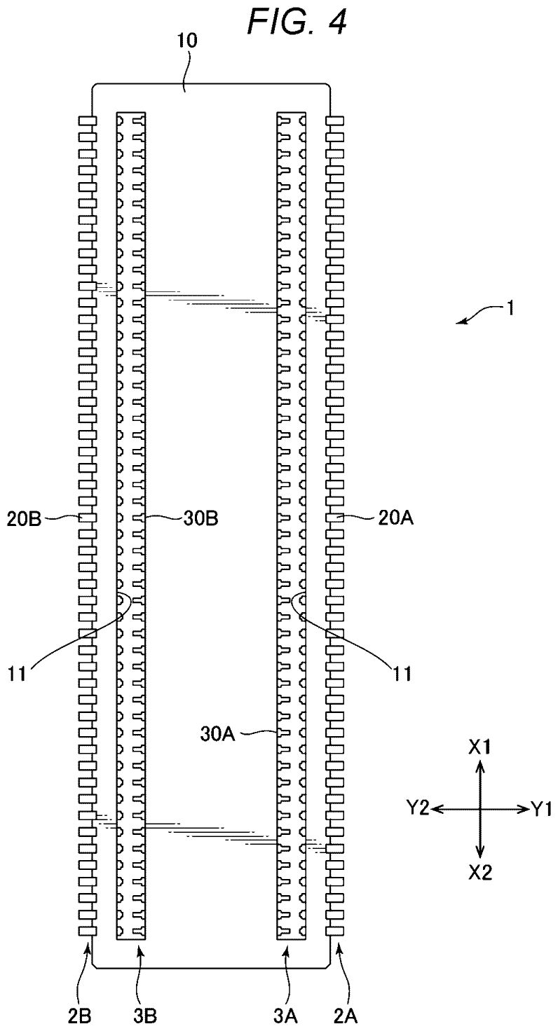

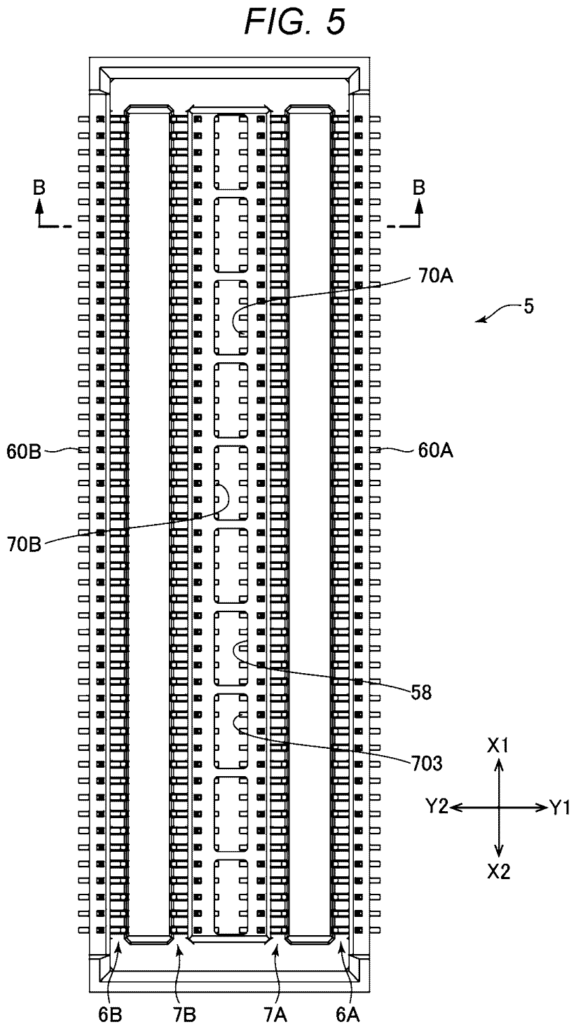

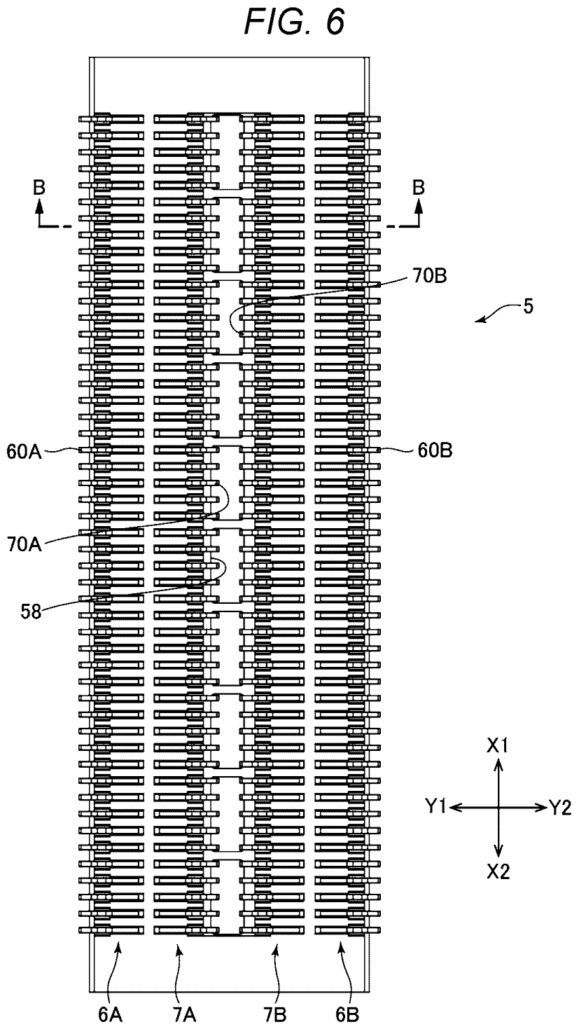

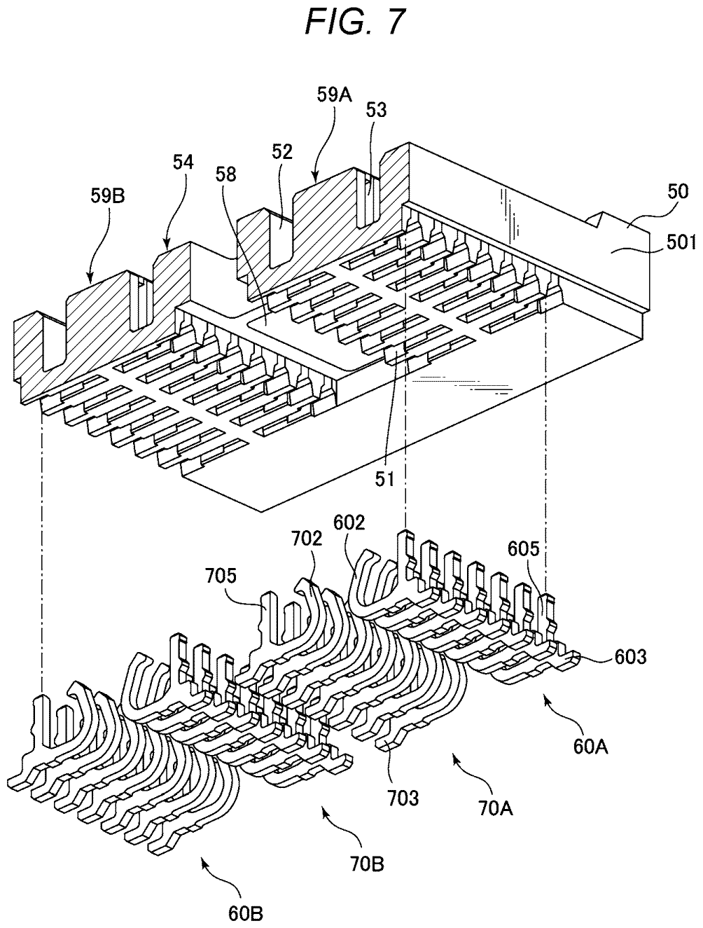

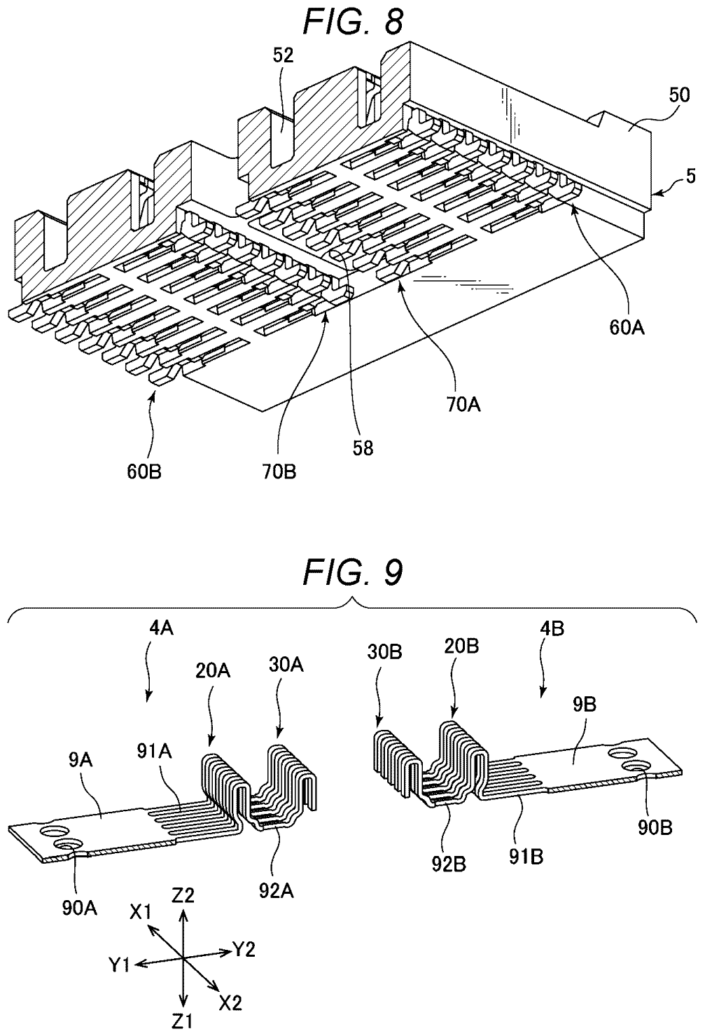

Next, in addition to FIGS. 1 and 2, the receptacle connector 5 will be described in more detail with reference to FIGS. 5 to 8. FIG. 5 shows a plan view of the receptacle connector 5, and FIG. 6 shows a bottom view. FIGS. 7 and 8 are partial sectional perspective views of a section taken along B-B line of FIGS. 5 and 6 from the bottom, FIG. 7 showing a state before the contacts 70 are fixed to the housing 50 and FIG. 8 showing a state after such fixing.

As in the contacts 20, 30 of the plug connector 1, each of the contacts 60A, 70A, 60B, 70B linearly extends along the Y-direction. The plurality of contacts 60A, 70A, 60B, 70B is arranged apart from each other at equal intervals in the X-direction. The plurality of contacts 60A, 70A forms contact rows 6A, 7A, and the plurality of contacts 60B, 70B forms contact rows 6B, 7B. That is, in the present embodiment, the receptacle connector 5 has four contact rows 6A, 7A, 6B, 7B.

The contact row 6A and the contact row 7A located adjacent to each other form one pair, and similarly, the contact row 7B and the contact row 6B located adjacent to each other form another pair. The contacts 60A forming the contact row 6A of the one pair and the contacts 70A forming the contact row 7A of the one pair are arranged at completely-overlapping locations in the Y-direction. Similarly, the contacts 60B forming the contact row 6B of the another pair and the contacts 70B forming the contact row 7B of the another pair extend along the Y-direction and are arranged at completely-overlapping locations in the Y-direction. Further, the pair of contacts 60A, 70A and the pair of contacts 60B, 70B are also arranged at completely-overlapping locations in the Y-direction.

The contact 60 has a base portion 600 and a press-fitting portion 605 extending along the Z-direction from the base portion 600. The press-fitting portion 605 is press-fitted in a press-fitting hole 55 through a housing groove 51 provided in a bottom portion of the housing 50a, and by such press-fitting, the contact 60 is fixed to the housing 50. In order to strengthen the fixing, the press-fitting portion 605 is provided with a press-fitting protrusion 605a.

Further, the contact 60 has, on one end side in the Y-direction, a mount portion 603 extending outward of the housing 10 from the base portion 600, and has, on the other end side, the elastic arm portion 602 connected to the base portion 600 through the horizontal bottom portion 601. The elastic arm portion 602 forms, together with the partition wall 57 of the housing 50, part of the fitting raised portion 59, and is elastically deformable in a clearance hole 53 provided in the partition wall 57. The elastic arm portion 602 forms the recessed portion 52 together with the horizontal bottom portion 601 and the peripheral wall 501 of the housing 50, particularly an inner wall 501a thereof. When the plug connector 1 and the receptacle connector 5 are fitted in each other, the contact point 607 provided at the tip end of the elastic arm portion 602 is contactable with a corresponding portion (contact portion 205a) of the plug connector 1.

As described above, the contact 70 has the same size and shape as those of the contact 60, and therefore, only differences of the contact 70 from the contact 60 will be mainly and briefly described. As in the contact 60, the contact 70 has a base portion 700, a press-fitting portion 705, a mount portion 703, the horizontal bottom portion 701, and the elastic arm portion 702. The elastic arm portion 702 forms the recessed portion 52 together with the horizontal bottom portion 701 and the center partition wall 56 of the housing 50. When the plug connector 1 and the receptacle connector 5 are fitted in each other, the contact point 707 provided at the tip end of the elastic arm portion 702 is contactable with a corresponding portion (contact portion 305a) of the plug connector 1. The center partition wall 56 has a through-hole 58 at the center. The through-hole 58 can be used for checking whether or not the mount portion 703 of the contact 70 is reliably attached to a board or the like when the receptacle connector 5 is mounted on the board.

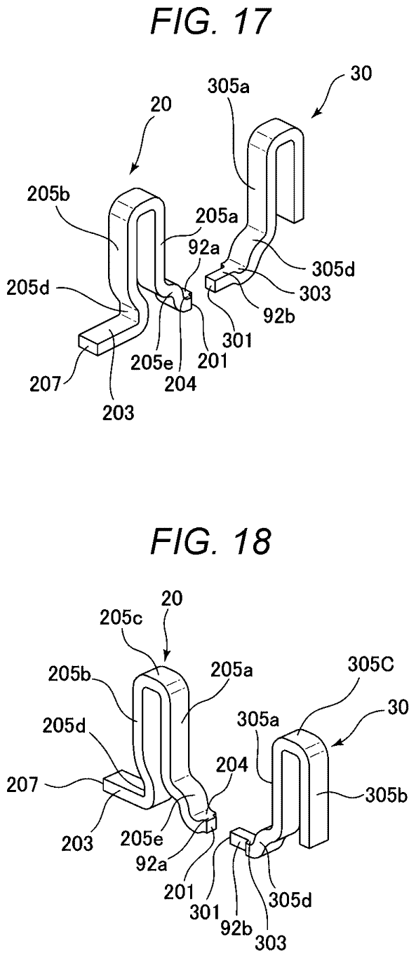

A method for manufacturing the plug connector 1 will be described with reference to FIGS. 9 to 18.

First, a thin flat metal plate is punched into a plurality of band-shaped members supported by (connected to) carriers 9A, 9B. One end of each of the plurality of band-shaped members in the Y-direction is coupled to the carrier 9A, 9B. Each of the plurality of band-shaped members extends from one end side to the other end side in the Y-direction.

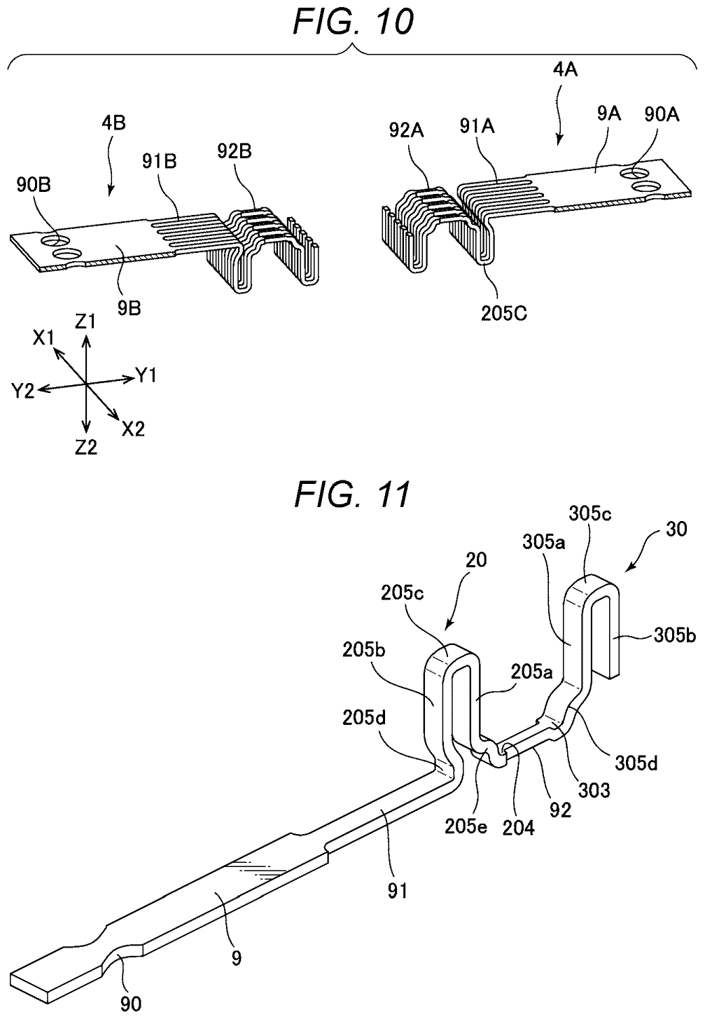

Subsequently, each band-shaped member is bent, and in this manner, contact assemblies 4A, 4B are formed. Specifically, an intermediate portion of each of the band-shaped portions between a first coupling portion 91 connected to the carrier 9 and a second coupling portion 92 located on the opposite side (other end side) of the first coupling portion 91 from the carrier 9 in the Y-direction is bent in the shape of the contact 20. Moreover, part of the band-shaped member located on the opposite side (other end side) of the second coupling portion 92 from the intermediate portion in the Y-direction is bent in the shape of the contact 30 by pressing. Thereafter, the resultant is plated, and as a result, the contact assemblies 4A, 4B shown in FIGS. 9 and 10 are formed. Note that in the description below, the intermediate portion between the first coupling portion 91 and the second coupling portion 92 may be referred to as a first intermediate portion.

In the manufacturing method of the present embodiment, the contact 20 and the contact 30 are arranged at the completely-overlapping locations in the Y-direction, and therefore, can be formed of one band-shaped member. Thus, a pitch between the contacts in the Y-direction can be easily narrowed, and the connector can be easily reduced in size.

Note that in the embodiment of the present disclosure, the “completely-overlapping locations” mean that the range of the width of one contact, which is manufactured from one band-shaped member, in the X-direction is within the range of the width (maximum width) of the other contact, which is manufactured from the same band-shaped member, in the X-direction.

At least some first contacts of the plurality of contacts 20 (first contacts) and at least some second contacts of the plurality of contacts 30 (second contacts) face each other in the Y-direction in one-to-one correspondence. Of one pair of contacts facing each other in the Y-direction as described above, the contact 20 and the contact 30 are arranged such that an area where the contact 20 is located is within an area where the contact 30 is located in the X-direction or an area where the contact 30 is located is within an area where the contact 20 is located in the X-direction. In other words, one pair of contact 20 and contact 30 facing each other is disposed such that one contact includes the other contact when viewed in the Y-direction.

FIG. 9 is a perspective view of part of the contact assemblies 4A, 4B in the X-direction from the top, and FIG. 10 is a perspective view from the bottom. FIGS. 11 and 12 are perspective views of a contact set. Each of the contact assemblies 4A, 4B includes a plurality of contact sets each of which includes the contacts 20, 30.

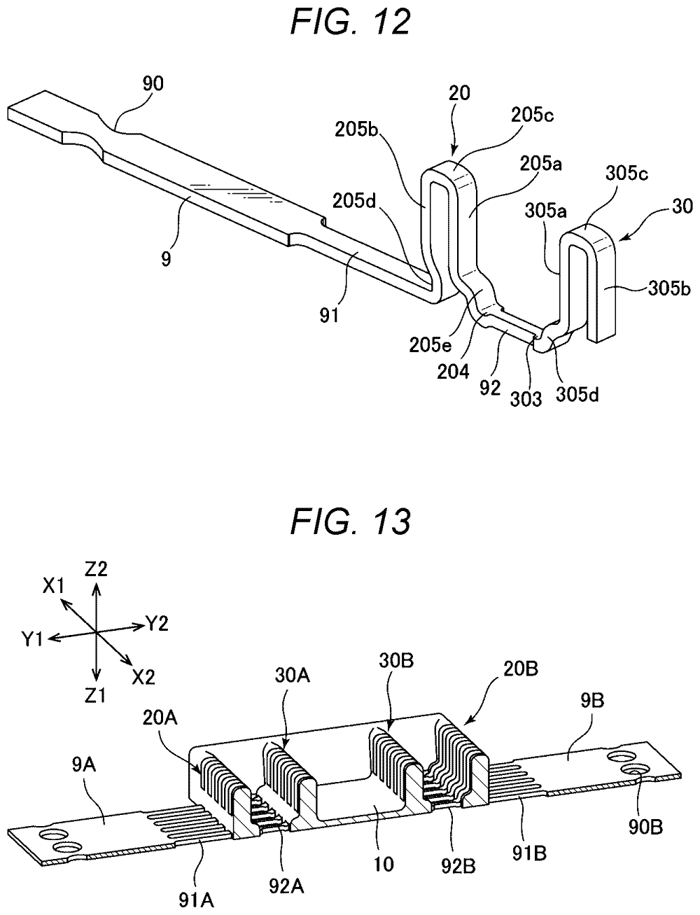

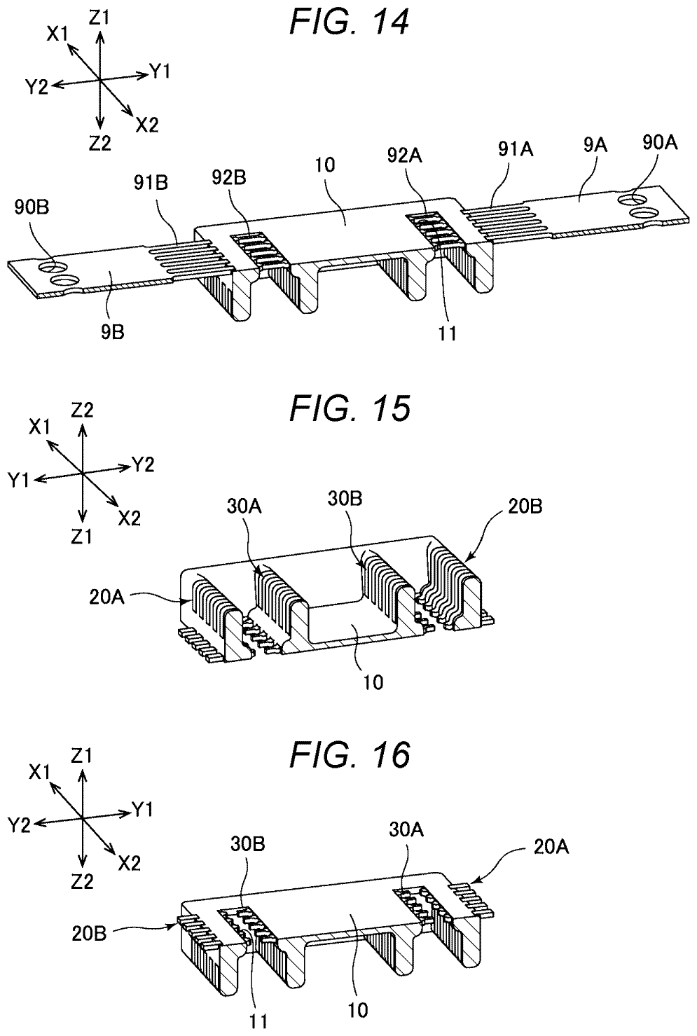

Subsequently, the contact assemblies 4A, 4B are conveyed to a molding machine (not shown) in a state of being attached to a conveyer (not shown) using pilot holes 90A, 90B provided in the carriers 9A, 9B. At this time, the carrier 9A is disposed on one side (Y1) in the Y-direction, and the band-shaped member is placed so as to extend to the other side (Y2) from the carrier 9A. On the other hand, the carrier 9B is disposed on the other side (Y2) in the Y-direction, and the band-shaped member is placed so as to extend to the one side (Y1) from the carrier 9B. In the molding machine, the band-shaped members connected to the carrier 9A and the band-shaped members connected to the carrier 9B are simultaneously insert-molded in a state of facing each other in the Y-direction and being symmetrically arranged in the Y-direction. As in FIG. 9, FIG. 13 is a perspective view of the molded contact assemblies 4A, 4B from the top. As in FIG. 10, FIG. 14 is a perspective view of the molded contact assemblies 4A, 4B from the bottom. By such molding, all the band-shaped members are integrally held by the housing 10.

Finally, the first coupling portion 91 of each band-shaped member is cut, and part of the second coupling portion 92 is cut out. In this manner, the plug connector 1 is completed. As a result, the plug connector 1 having the four contact rows 2A, 3A, 2B, 3B can be manufactured. For example, part of the first coupling portions 91 of the band-shaped members connected to the carrier 9A is cut out without removing part of the first coupling portions 91 of the band-shaped members connected to the carrier 9B, and in this manner, a plug connector 1 having three contact rows can be manufactured.

As in FIG. 9, FIG. 15 is a perspective view of the molded contact assemblies 4A, 4B from the top. As in FIG. 10, FIG. 16 is a perspective view of the molded contact assemblies 4A, 4B from the bottom.

Further, similarly to FIGS. 11 and 12, FIGS. 17 and 18 show perspective views of the contacts 20, 30 of the contact assemblies obtained as a result of the cutting step, i.e., the final shapes of the contacts 20, 30. Particularly, when part of the second coupling portions 92 is cut out, the through-hole 11 provided along the Z-direction in the housing 10 can be used.

In a conventional configuration described as an example in JP-A-2021-44080, a coupling portion connecting contacts forming one of two adjacent contact rows to a carrier and a coupling portion connecting contacts forming the other contact row to the carrier are provided at non-overlapping locations in a direction perpendicular to a row arrangement direction.

In the manufacturing method of the present disclosure, both the contact 20 and the contact 30 are formed of one band-shaped member, and therefore, the amount of waste from the first coupling portion 91 and the second coupling portion 92 due to the above-described cutting and removal process can be extremely smaller than that of the conventional configuration disclosed in JP-A-2021-44080. Thus, resources can be more effectively used as compared to the prior art.

The cut part of the first coupling portion 91 finally forms the first mount portion 203 of the contact 20. Similarly, the cut part of the second coupling portion 92 finally forms the second mount portion 92a of the contact 20 and the third mount portion 92b of the contact 30. Thus, on this point, the resources can also be effectively used.

The second mount portion 92a and the third mount portion 92b are extremely close to each other in the Y-direction, and therefore, the portion to be removed from the second coupling portion 92 is slight, and therefore, the waste amount can be reduced. Here, the second mount portion 92a and the third mount portion 92b are originally the portion coupling between the portion bent in the shape of the contact 20 and the portion bent in the shape of the contact 30, and therefore, the cut surface 201 of the second mount portion 92a and the cut surface 301 of the third mount portion 92b are located at opposing locations in the Y-direction. Further, in a case where these cut surfaces 301, 201 are formed by cutting along the direction perpendicular to the “X-Y” plane, these surfaces face each other in the Y-direction. Note that needless to say, these cut surfaces, i.e., the cut surfaces 201, 301, and the cut surface 207 of the first mount portion 203 are not plated.

The present disclosure is not limited to the embodiment described above, and includes embodiments changed as necessary without departing from the gist of the disclosure.

For example, in the present embodiment, all the contacts 20 forming the contact row 2 are in one-to-one correspondence with all the contacts 30 forming the contact row 3, and these contacts are arranged at the completely-overlapping locations in the Y-direction. However, only some of the plurality of contacts 20 and some of the plurality of contacts 30 may be in one-to-one correspondence, and may be arranged at the completely-overlapping locations in the Y-direction. In other words, at least some of the contacts 20 and at least some of the contacts 30 may be arranged at the completely-overlapping locations in the Y-direction. In this case, the manufacturing method described in the embodiment above is applied only to these contacts arranged at the completely-overlapping locations in the Y-direction.

The plug connector 1 is not necessarily in the symmetrical shape in the X-direction and the Y-direction.

The connector of the present disclosure may further have a third contact row (not shown) in addition to the first contact row (contact row 2) and the second contact row (contact row 3). As in the contact rows 2, 3, the third contact row also linearly extends along the X-direction. The third contact row is apart from the second contact row (contact row 3) in the Y-direction, and is provided inward of the housing 10 with respect to the second contact row. A plurality of third contacts forming the third contact row extends along the Y-direction, and is arranged apart from each other at equal intervals in the X-direction. At least some of the plurality of third contacts are arranged, in the Y-direction, at locations completely overlapping with at least some of the contacts 20 forming the contact row 2 (first contact row) and at least some of the contacts 30 forming the contact row 3 (second contact row).

Hereinafter, an example of a method for manufacturing a plug connector having the third contact row will be described. The plug connector is manufactured in the following manner, so that the first contact row, the second contact row, and the third contact row can be formed from one band-shaped member.

First, the first intermediate portion of each band-shaped member between the first coupling portion 91 connected to the carrier 9 and the second coupling portion 92 located on the opposite side of the first coupling portion 91 from the carrier 9 in the Y-direction is bent in the shape of the contact 20. Moreover, a second intermediate portion between the second coupling portion 92 and a third coupling portion (not shown) located on the opposite side of the second coupling portion 92 from the first intermediate portion in the Y-direction is bent in the shape of the contact 20. Further, part of the band-shaped member located on the opposite side of the third coupling portion from the second intermediate portion in the Y-direction is bent in the shape of the third contact.

Thereafter, the first coupling portion 91 is cut from the carrier 9, and part of the second coupling portion 92 and part of the third coupling portion are cut out.

In this case, the second contact has a fourth cut surface (not shown), and the third contact has a fifth cut surface (not shown). The fourth cut surface of the second contact is located, in the Y-direction, on the opposite side of the cut surface 301 of the third mount portion 92b. The fourth cut surface of the second contact and the fifth cut surface of the third contact are formed along the direction perpendicular to the “X-Y” plane, and in the Y-direction, are located between the contact row 3 (second contact row) and the third contact row.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A connector comprising:
a housing; and
a plurality of contact rows held by the housing,
wherein the plurality of contact rows linearly extends along a first direction, is apart from each other in a second direction perpendicular to the first direction, and includes at least a first contact row and a second contact row arranged adjacent to each other in the second direction,
the first contact row includes a plurality of first contacts, the second contact row includes a plurality of second contacts, and each of the plurality of first contacts and each of the plurality of second contacts extend along the second direction,
at least some of the plurality of first contacts and at least some of the plurality of second contacts face each other in the second direction, a pair of opposing first and second contacts is disposed such that one of the first and second contacts includes the other one of the first and second contacts when viewed in the second direction, and
each of the plurality of first contacts has a first cut surface formed along a direction crossing a plane formed by the first direction and the second direction, each of the plurality of second contacts has a second cut surface formed along the direction crossing the plane formed by the first direction and the second direction, and the first cut surface and the second cut surface are located between the first contact row and the second contact row in the second direction.

2. The connector according to claim 1, wherein
each of the plurality of first contacts has a first mount portion extending outward of the housing in the second direction, and
each of the plurality of second contacts has a second mount portion extending outward of the housing in the second direction.

3. The connector according to claim 1, wherein
each of the plurality of first contacts has a third mount portion extending inward of the housing in the second direction.

4. The connector according to claim 2, wherein
the plurality of first contacts is located outward of the housing in the second direction with respect to the plurality of second contacts, and
the first mount portion is formed with a third cut surface along the direction crossing the plane formed by the first direction and the second direction.

5. The connector according to claim 2, wherein
the plurality of second contacts is located inward of the housing in the second direction with respect to the plurality of first contacts, and
the second mount portion is formed with the second cut surface.

6. The connector according to claim 3, wherein
the third mount portion is formed with the first cut surface.

7. The connector according to claim 1, wherein
each of the plurality of first contacts has a first contact portion, and the first contact portion is located between the first contact row and the second contact row and extends along a third direction perpendicular to both the first direction and the second direction, and
each of the plurality of second contacts has a second contact portion, and the second contact portion is located between the first contact row and the second contact row and extends along the third direction.

8. The connector according to claim 1, wherein
the housing has a through-hole, and
the through-hole penetrates, between the first cut surface and the second cut surface in the second direction, the housing along the direction crossing the plane formed by the first direction and the second direction.

9. The connector according to claim 1, wherein
the plurality of contact rows includes a third contact row,
the third contact row linearly extends along the first direction, and is provided apart from the second contact row in the second direction and inward of the housing with respect to the second contact row,
the third contact row includes a plurality of third contacts, and each of the plurality of third contacts extends along the second direction,
at least some of the plurality of third contacts face, in the second direction, at least some of the plurality of first contacts and at least some of the plurality of second contacts, a pair of opposing third and first contacts is arranged such that one of the third and first contacts includes the other one of the third and first contacts when viewed in the second direction, and a pair of opposing third and second contacts is arranged such that one of the third and second contacts includes the other one of the third and second contacts when viewed in the second direction, and
each of the plurality of second contacts has a fourth cut surface formed along the direction crossing the plane formed by the first direction and the second direction, each of the plurality of third contacts has a fifth cut surface formed along the direction crossing the plane formed by the first direction and the second direction, and the fourth cut surface and the fifth cut surface are located between the second contact row and the third contact row in the second direction.

10. The connector according to claim 1, wherein
the plurality of contact rows is symmetrically arranged in the second direction.

11. The connector according to claim 1, wherein
the housing is formed to hold the plurality of contacts in the housing by insert molding.

12. A method for manufacturing the connector according to claim 1, comprising:
punching a metal plate to form a plurality of band-shaped members connected to each other through a carrier on one end side in the second direction;
bending, in a shape of the first contact, a first intermediate portion of each of the plurality of band-shaped members between a first coupling portion located on the one end side in the second direction and a second coupling portion located on the other end side in the second direction;
bending, in a shape of the second contact, part of each of the plurality of band-shaped members located on the other end side in the second direction with respect to the second coupling portion;
forming the housing such that the housing holds at least part of each of the plurality of band-shaped members;
cutting the carrier and the first coupling portion; and
cutting out part of the second coupling portion.

13. A method for manufacturing the connector according to claim 9, comprising:
punching a metal plate to form a plurality of band-shaped members connected to each other through a carrier on one end side in the second direction;
bending, in a shape of the first contact, a first intermediate portion of each of the plurality of band-shaped members between a first coupling portion located on the one end side in the second direction and a second coupling portion located on the other end side in the second direction;
bending, in a shape of the second contact, a second intermediate portion of each of the plurality of band-shaped members between the second coupling portion and a third coupling portion located on the other end side in the second direction with respect to the second coupling portion;
bending, in a shape of the third contact, part of each of the plurality of band-shaped members located on the other end side in the second direction with respect to the third coupling portion;
cutting the carrier and the first coupling portion;
removing part of the second coupling portion; and
removing part of the third coupling portion.

14. The method for manufacturing the connector according to claim 12,
the plurality of band-shaped members including a plurality of first band-shaped members and a plurality of second band-shaped members, further comprising:
forming each of the plurality of first band-shaped members such that the each of the plurality of first band-shaped members extends from a first carrier disposed on one side in the second direction to the other side, and forming each of the plurality of second band-shaped members such that the each of the plurality of second band-shaped members extends from a second carrier disposed on the other side in the second direction to the one side;
bending the first intermediate portion of each of the plurality of first band-shaped members in the shape of the first contact, and bending the first intermediate portion of each of the plurality of second band-shaped members in the shape of the first contact;
bending the part of each of the plurality of first band-shaped members in the shape of the second contact, and bending the part of each of the plurality of second band-shaped members in the shape of the second contact;
forming the housing such that the housing holds at least part of each of the first band-shaped members and at least part of each of the second band-shaped members in a state of the plurality of first band-shaped members and the plurality of second band-shaped members facing each other in the second direction;
cutting the first carrier and the first coupling portion of each of the first band-shaped members, and cutting the second carrier and the first coupling portion of each of the second band-shaped members; and
removing part of the second coupling portion of each of the first band-shaped members and part of the second coupling portion of each of the second band-shaped members.

15. The method for manufacturing the connector according to claim 14, further comprising:
forming the housing such that the housing holds at least part of each of the first band-shaped members and at least part of each of the second band-shaped members in a state of the first band-shaped members and the second band-shaped members being symmetrically arranged in the second direction.

16. The method for manufacturing the connector according to claim 12, wherein
part of the first coupling portion forms a first mount portion of each of the plurality of first contacts, and the first mount portion extends outward of the housing in the second direction.

17. The method for manufacturing the connector according to claim 12, wherein
part of the second coupling portion forms at least part of a second mount portion of each of the plurality of second contacts, and the second mount portion extends outward of the housing in the second direction.

18. The method for manufacturing the connector according to claim 12, wherein
part of the second coupling portion forms at least part of a third mount portion of each of the plurality of first contacts, and the third mount portion extends inward of the housing in the second direction.

19. The method for manufacturing the connector according to claim 12, further comprising:
cutting out part of the second coupling portion using a through-hole penetrating the housing along the direction crossing the plane formed by the first direction and the second direction.

20. The method for manufacturing the connector according to claim 12, wherein
the housing is formed to hold the plurality of contacts by insert molding.
